(19) United States
(12) Patent Application Publication
(10) Pub. No.: US 2024/0286182 A1
(43) Pub. Date: Aug. 29, 2024

(54) WIPING APPARATUS AND ROLLING FACILITY

(71) Applicant: PRIMETALS TECHNOLOGIES JAPAN, LTD., Hiroshima-shi, Hiroshima (JP)

(72) Inventors: Yoichi MATSUI, Hiroshima-shi (JP); Yuta ODAWARA, Hiroshima-shi (JP)

(73) Assignee: PRIMETALS TECHNOLOGIES JAPAN, LTD., Hiroshima-shi, Hiroshima (JP)

(21) Appl. No.: 18/573,697

(22) PCT Filed: Jul. 26, 2021
(86) PCT No.: PCT/JP2021/027513

§ 371 Date: Dec. 22, 2023

(51) Int. Cl. B21B 45/02

(52) U.S. Cl. CPC B21B 45/0278

(57) ABSTRACT

A wiping apparatus for removing a liquid from a surface of a strip of metal being conveyed includes a wiping member having a flat face disposed to be contactable with the surface of the strip. The wiping member is formed from a graphite fiber reinforced resin composite material.

### TECHNICAL FIELD

The present disclosure relates to a wiping apparatus and a rolling facility.

### BACKGROUND

In a rolling facility for rolling a metal strip, rolling is performed while supplying liquid coolant to a mill roll. If the coolant remains on a surface of the rolled strip, it may become a quality problem. Therefore, a wiping apparatus for removing a liquid, such as coolant, from the surface of the strip has been proposed.

Patent Documents 1 and 2 each describe a wiping apparatus that includes a stationary (contact-type) wiper extending in a direction orthogonal to a conveying direction of a metal strip and disposed so as to contact a surface of the strip, downstream of a mill roll for rolling the strip.

### CITATION LIST

### Patent Literature

Patent Document 1: JPH1-130808A
Patent Document 2: JP2019-25532A

### SUMMARY

### Technical Problem

Compared to a roll-type wiper, the stationary (contact-type) wiper has an advantage that, for example, the liquid, such as the coolant, removed from the surface of the strip by the wiper hardly splashes into a surrounding area or the wiper and the strip contact more evenly in a strip width direction, and thus unevenness in wiping hardly occurs.

On the other hand, the stationary wiper is prone to wear due to friction with the strip. For this reason, replacement frequency of the stationary wiper is generally high. Further, wear debris may be generated due to wear of the wiper and wear of the mill roll or the strip due to a rolling operation, and this wear debris may be stuck between the wiper and the strip (rolled material), form a lump, and scratch the surface of the strip. Furthermore, a contact area between the wiper and the strip is usually set narrow in order to suppress heat generation or the wear due to the friction. Consequently, however, a high surface pressure acts on a contact portion of the wiper and the strip in the case of the wiper or the like formed from a hard material, deforming a wiper surface and causing unevenness. Then, the wiper and the strip partially contact each other, which may scratch the surface of the strip due to the even higher surface pressure partially acting on the contact portion.

In view of the above, an object of at least one embodiment of the present invention is to provide a rolling facility and a wiping apparatus which hardly scratches a surface of a metal strip and can reduce replacement frequency of a wiping member.

### Solution to Problem

A wiping apparatus according to at least one embodiment of the present invention is a wiping apparatus for removing a liquid from a surface of a strip of metal being conveyed, including: a wiping member having a flat face disposed to be contactable with the surface of the strip. The wiping member is formed from a graphite fiber reinforced resin composite material.

Further, a rolling facility according to at least one embodiment of the present invention, includes: a mill roll for rolling a strip of metal; and the above-described wiping apparatus disposed downstream of the mill roll in a conveying direction of the strip.

### Advantageous Effects

According to at least one embodiment of the present invention, provided are a rolling facility and a wiping apparatus which hardly scratches a surface of a metal strip and can reduce replacement frequency of a wiping member.

### BRIEF DESCRIPTION OF DRAWINGS

FIG. 1 is a schematic view of a rolling facility including a wiping apparatus according to an embodiment.

FIG. 2 is a schematic planar view of the wiping apparatus in the rolling facility shown in FIG. 1.

FIG. 3 is a schematic view of a first wiper of the wiping apparatus according to an embodiment.

FIG. 4 is a schematic view of the first wiper of the wiping apparatus according to an embodiment.

FIG. 5 is a schematic view of the first wiper of the wiping apparatus according to an embodiment.

FIG. 6 is a schematic view of a first wiper and a rubber wiper of the wiping apparatus according to an embodiment.

FIG. 7 is a schematic view of a non-woven wiper of the wiping apparatus according to an embodiment.

FIG. 8 is a schematic view of a second wiper of the wiping apparatus according to an embodiment.

FIG. 9 is a schematic view of the second wiper of the wiping apparatus according to an embodiment.

FIG. 10 is a schematic cross-sectional view of a typical stationary wiper.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

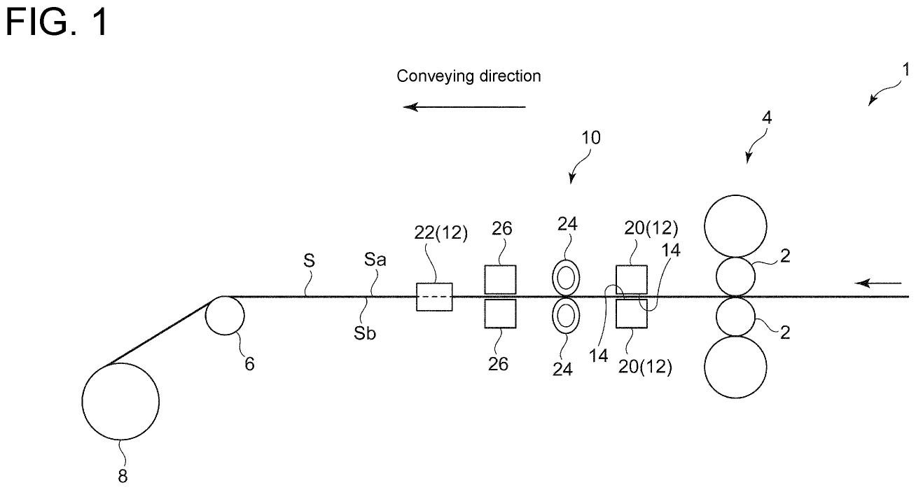

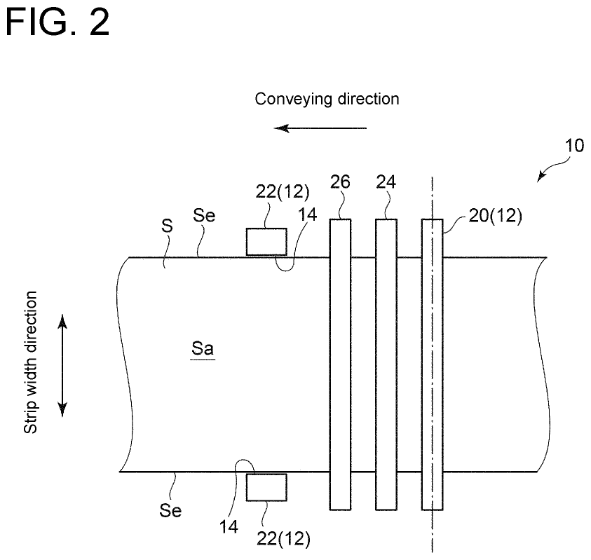

FIG. 1 is a schematic view of a rolling facility including a wiping apparatus according to some embodiments. FIG. 2 is a schematic planar view of the wiping apparatus in the rolling facility shown in FIG. 1.

As shown in FIG. 1, a rolling facility 1 according to an embodiment includes a rolling mill 4 including mill rolls 2 for rolling a strip S of metal (steel, etc.), and a wiping apparatus 10 disposed downstream of the mill rolls 2 in a conveying direction of the strip S. As shown in FIG. 1, the rolling facility I may include a winding device 8 for winding the strip S rolled by the mill rolls 2, and may include a guide roll 6 disposed between the mill rolls 2 and the winding device 8 and configured to guide the strip S to the mill rolls 2. The wiping apparatus 10 may be disposed between the mill rolls 2 and the winding device 8 in the conveying direction of the strip S.

In the rolling mill 4, rolling is performed while supplying liquid coolant to the mill rolls 2. Thus, the coolant adheres to the surface of the strip S that has passed through the mill rolls 2. The wiping apparatus 10 is a wiping apparatus for removing a liquid, such as the coolant, from the surface of the strip S by wiping.

In some embodiments, the wiping apparatus 10 includes a wiping member 12 having a flat face 14 disposed to be contactable with the surface of the strip S. The wiping member 12 is formed from a graphite fiber reinforced resin composite material.

In the exemplary embodiments shown in FIGS. 1 and 2, the wiping apparatus 10 includes a first wiper 20 and a second wiper 22 each of which includes the above-described wiping member 12. The wiping member 12 forming the first wiper 20 has the flat face 14 disposed to be contactable with rolled faces Sa, Sb of the strip S. The wiping member 12 forming the second wiper 22 has the flat face 14 disposed to be contactable with end faces Se of the strip S in a strip width direction. In some embodiments, the wiping apparatus 10 may include only either of the first wiper 20 or the second wiper 22.

The rolled face Sa, Sb of the strip S means, of the surface of the strip S, a face to be rolled by the mill rolls 2 or a face rolled by the mill rolls 2 (a face in contact with outer circumferential surfaces of the mill rolls 2). Further, the end faces Se of the strip S in the strip width direction mean, of the surface of the strip S, faces connecting the pair of rolled faces Sa, Sb (the upper rolled face Sa and the lower rolled face Sb) of the strip S to each other at both end portions of the strip S in the strip width direction.

The wiping apparatus 10 may include a pressing part configured to press the wiping member 12 toward the surface of the strip S. The flat face 14 of the wiping member 12 can be brought into contact with the surface of the strip S by pressing the wiping member 12 against the strip S with the pressing part. The pressing part may include, for example, a hydraulic cylinder or a pneumatic cylinder, or an elastic member such as a spring.

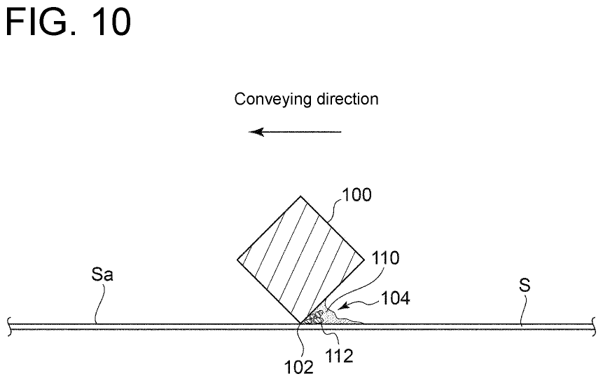

In a stationary (contact-type) wiper, heat or wear due to friction with the strip is often noticeable, and replacement frequency of such wiper is generally high. Further, in the conventional stationary (contact-type) wiper, a contact area between the wiper and the strip is usually set narrow in order to reduce heat or wear due to friction with the strip. For example, in a typical stationary wiper, wiping is performed with a corner 102 of a wiper 100 having a rectangular cross section in contact with the surface of the strip S, as shown in FIG. 10. FIG. is a schematic cross-sectional view of the typical stationary wiper 100. In this case, in a narrow region 104 (a region between the wiper 100 and the strip S) adjacent to the wiper 100 on the upstream side of the wiper 100, a foreign matter 112, such as wear debris of the wiper 100 or metal powder which is mixed in coolant 110 and is generated by wear of the mill roll or the strip, accumulates and forms a lump. Such foreign matter 112 may scratch the surface of the strip S. Alternatively, in the case of a wiper or the like formed from a hard material, when the wiper 100 is pressed against the strip S by the pressing part or the like, a high surface pressure acts on a contact portion (corner 102) of the wiper 100 with the strip S, which can deform the surface (corner 102) of the wiper 100 and cause unevenness. Then, the corner 102 of the wiper 100 and the strip S partially contact each other, which may scratch the surface of the strip S due to the even higher surface pressure partially acting on the contact portion.

In the above-described embodiments, since the wiping member 12 (the member forming the first wiper 20 and the second wiper 22) is formed from the graphite fiber reinforced resin composite material having self-lubricating properties and a low coefficient of friction with a metal material, heat or wear due to friction between the wiping member 12 and the strip S is hardly generated. Therefore, it is possible to reduce the replacement frequency of the wiping member 12, and since wear debris due to wear of the wiping member 12 is hardly generated, it is possible to suppress the scratch on the surface of the strip S due to the wear debris. Further, in the above-described embodiments, since heat or wear due to friction between the wiping member 12 and the strip S is hardly generated, it is possible to bring the relatively wide flat face 14 of the wiping member 12 into contact with the face (the rolled face Sa, Sb or the end face Se) of the strip S. By thus bringing the relatively wide flat face 14 of the wiping member 12 into contact with the surface of the strip S, a local force hardly acts on the contact portion of the wiping member 12 and the surface of the strip S in the state where the wiping member 12 is pressed against the surface of the strip S, and thus, unevenness is hardly formed on the surface of the wiping member. Therefore, it is possible to suppress partial contact between the surface of the wiping member 12 and the strip S, and it is possible to suppress the scratch on the surface of the strip S due to the local surface pressure that may be generated by such partial contact. Therefore, according to the above-described embodiments, the surface of the metal strip S is hardly scratched when the surface of the strip S is wiped, and the replacement frequency of the wiping member 12 can be reduced.

The graphite fiber reinforced resin composite material which is the material for the wiping member 12 may include a polyimide graphite fiber reinforced composite (PGFC).

In this case, since the material including the polyimide graphite fiber reinforced composite with the self-lubricating properties is used as the graphite fiber reinforced resin composite material forming the wiping member 12, it is possible to effectively suppress heat or wear due to friction between the wiping member 12 and the strip S. Therefore, the surface of the metal strip S is hardly scratched when the surface of the strip S is wiped, and the replacement frequency of the wiping member 12 can be reduced.

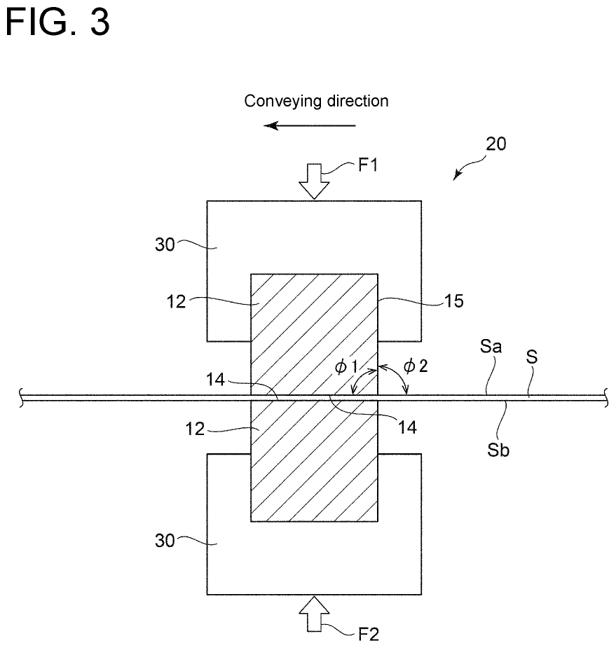

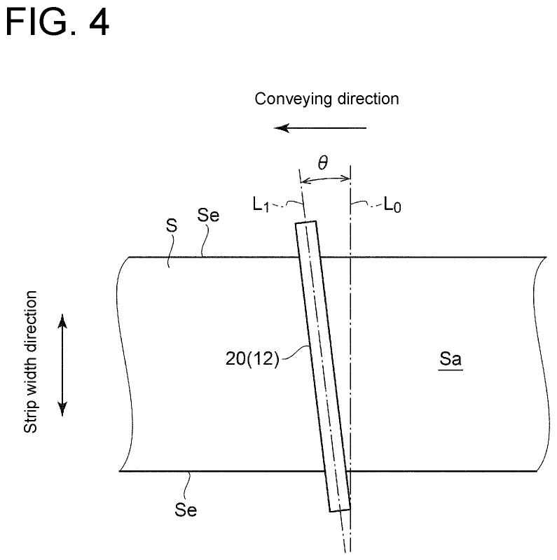

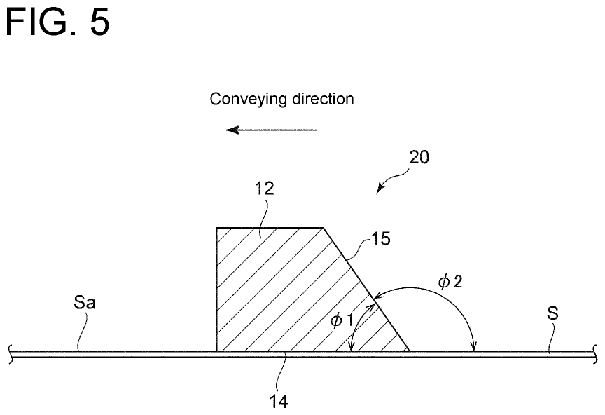

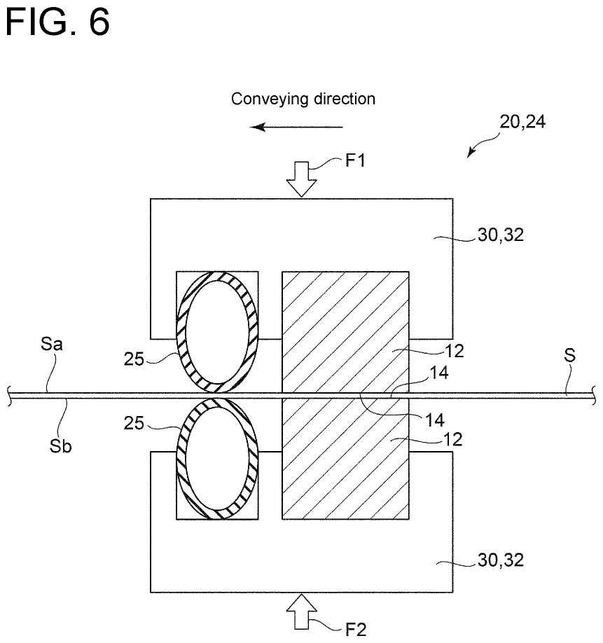

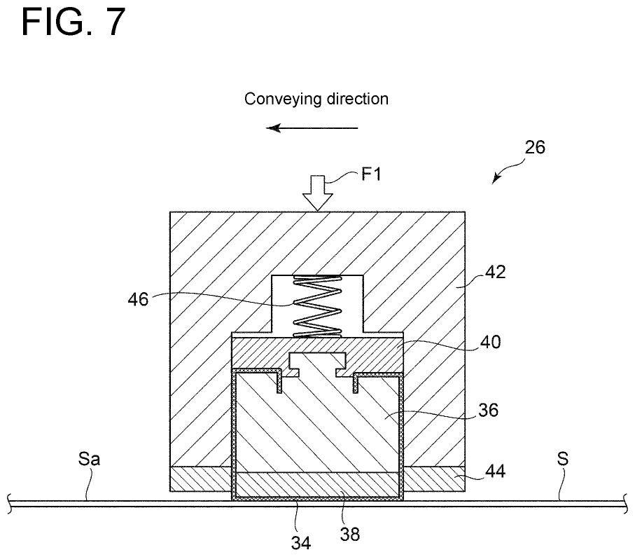

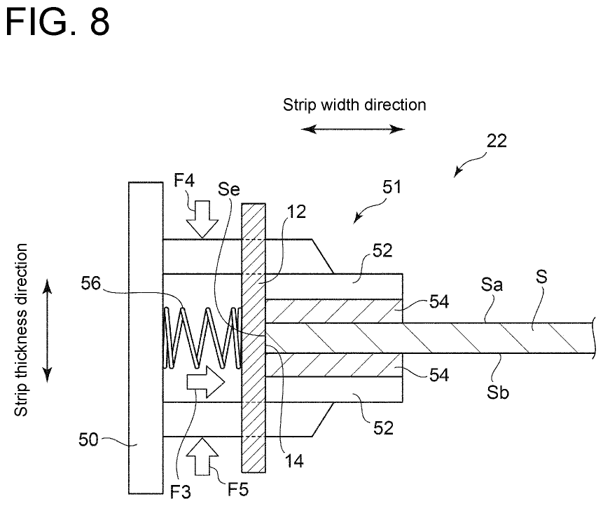

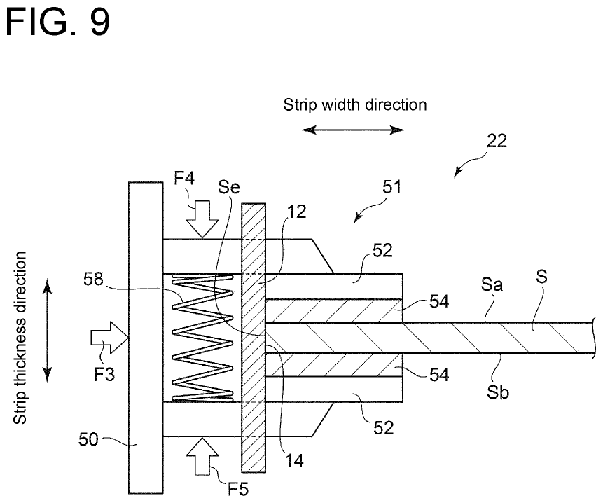

FIGS. 3 to 5 are each a schematic view of the first wiper 20 of the wiping apparatus according to an embodiment. Thereamong, FIGS. 3 and 5 are the views showing the cross section of the first wiper 20 orthogonal to the strip width direction of the strip S, and FIG. 4 is a planar view of the first wiper 20. FIG. 6 is a schematic view of the first wiper 20 and a rubber wiper 24 of the wiping apparatus 10 according to an embodiment, and FIG. 7 is a schematic view of a non-woven wiper 26 of the wiping apparatus 10 according to an embodiment. FIGS. 8 and 9 are each a schematic cross-sectional view of the second wiper 22 of the wiping apparatus 10 according to an embodiment. FIGS. 8 and 9 are the views showing cross sections of the second wiper 22 at mutually different positions in the conveying direction of the strip S.

In some embodiments, as shown in FIGS. 1, 3 and 6, the first wiper 20 may include a pair of wiping members 12 having the flat faces 14 disposed so as to contact the upper rolled face Sa and the lower rolled face Sb of the strip S, respectively.

In some embodiments, for example, as shown in FIGS. 3 and 6, the first wiper 20 may include a holding member 30 holding the wiping member 12. The above-described pressing part may apply pressing forces (forces to press the wiping member 12 against the strip S) F1, F2 to the wiping member 12 via the holding member 30.

The wiping member 12 of the first wiper 20 shown in FIGS. 1 to 6 is disposed so as to extend along the strip width direction of the strip S.

Since the wiping member 12 of the first wiper 20 thus extends along the strip width direction of the strip S, the liquid on the rolled faces Sa, Sb of the strip S conveyed along the longitudinal direction (conveying direction) of the strip S can more effectively be removed by the first wiper 20.

In some embodiments, for example, as shown in FIG. 4, the wiping member 12 of the first wiper 20 is disposed so as to extend in a direction oblique to the strip width direction of the strip S.

In the above-described embodiments, since the wiping member 12 of the first wiper extends in the direction oblique to the strip width direction, the liquid removed from the surface of the strip S by the wiping member 12 is less likely to accumulate upstream of the wiping member 12 and more likely to be discharged along the wiping member 12 toward lateral to the strip width direction. Therefore, it is possible to facilitate discharge of the foreign matter (a solid matter (such as metal powder etc. generated by wear of the mill roll or the strip, or wear debris etc. of the wiping member) mixed in the coolant) contained in the liquid, and it is possible to more effectively suppress the scratch on the surface of the strip S due to the foreign matter.

As in the above-described embodiments, by arranging the wiping member 12 to be oblique to the strip width direction, the contact area between the wiping member 12 and the strip S is increased compared to a case where the wiping member 12 is arranged so as to extend in the strip width direction. In this regard, since the wiping member 12 forming the first wiper is formed from the graphite fiber reinforced resin composite material (the material having the self-lubricating properties and the low coefficient of friction with the metal material), it is possible to effectively suppress the generation of heat or wear due to friction between the wiping member 12 and the strip S even if the contact area between the wiping member 12 and the strip S is increased. Therefore, as in the above-described embodiments, the wiping member 12 of the first wiper 20 can be disposed so as to extend in the direction oblique to the strip width direction of the strip S.

In the above-described embodiments, an oblique angle θ (see FIG. 4) of an extension direction (indicated by a straight line L1 in FIG. 4) of the wiping member 12 of the first wiper with respect to the strip width direction (indicated by a straight line L0 in FIG. 4) may be, for example, not less than 1 degree and not greater than 45 degrees, or more preferably not less than 3 degrees and not greater than 10 degrees. Since the above-described oblique angle θ is not less than 1 degree or not less than 3 degrees, the liquid accumulating upstream of the wiping member 12 can effectively be discharged along the wiping member 12 toward lateral to the strip width direction. Further, since the above-described oblique angle θ is not greater than 45 degrees or not greater than 10 degrees, the length of the wiping member 12 hardly becomes excessive, making it possible to suppress an increase in size of the wiping apparatus 10.

In some embodiments, for example, as shown in FIG. 5, the wiping member 12 of the first wiper 20 has an upstream face 15 connected to the flat face 14 at an upstream end of the flat face 14 in the conveying direction of the strip S. Then, an angle φ1 between the flat face 14 and the upstream face 15 is greater than 0 degrees and less than 90 degrees in a cross section orthogonal to the strip width direction of the strip S.

In the above-described embodiments, the angle φ1 between the flat face 14 and the upstream face 15 of the wiping member 12 is greater than 0 degrees and less than 90 degrees in the cross section orthogonal to the strip width direction. That is, an angle φ2 (see FIG. 5) between the upstream face 15 of the wiping member 12 and a portion, of the rolled face (in FIG. 5, the rolled face Sa) of the strip S, upstream of the wiping member 12 is an obtuse angle in the above-described cross section. Therefore, compared to a case where the angle φ2 is not greater than 90 degrees, the liquid and the foreign matter (the solid matter (such as metal powder etc. generated by wear of the mill roll or the strip, or wear debris etc. of the wiping member 12) mixed in the coolant) contained in the liquid are easily discharged from a region between the upstream face 15 of the wiping member 12 and the rolled face of the strip S. Therefore, it is possible to facilitate the discharge of the liquid and the foreign matter from the above-described region, and it is possible to more effectively suppress the scratch on the surface of the strip due to the foreign matter.

In the embodiment shown in FIG. 3, the angle φ1 and the angle φ2 described above are approximately 90 degrees.

As shown in FIGS. 1 and 2, the wiping apparatus 10 may include the rubber wiper 24 disposed downstream of the first wiper 20 in the conveying direction of the strip S. As shown in FIG. 6, the rubber wiper 24 may include a rubber tube 25 extending along the strip width direction of the strip S, and a holding member 32 for holding the rubber tube 25. The rubber tube 25 is disposed to be contactable with the rolled faces Sa and/or Sb of the strip S. As shown in FIG. 6, the holding member 30 holding the wiping member 12 of the first wiper and the holding member 32 for holding the rubber tube 25 of the rubber wiper 24 may integrally be formed.

According to the above configuration, since the rubber wiper 24 including the rubber member (rubber tube 25) contactable with the rolled faces Sa, Sb is disposed downstream of the first wiper 20, the liquid that could not completely be removed from the rolled faces Sa, Sb of the strip S by the first wiper 20 can be removed by the rubber wiper 24. Thus, the liquid can more reliably be removed from the rolled faces Sa, Sb of the strip S.

Since the rubber wiper 24 disposed downstream of the first wiper 20 has the role of performing auxiliary wiping, a pressing force applied to the rubber wiper 24 (a force to press the rubber tube 25 against the strip S) can relatively be small. Therefore, it is possible to suppress wear of the rubber wiper 24 due to friction with the strip S.

As shown in FIGS. 1 and 2, the wiping apparatus 10 may include the non-woven wiper 26 disposed downstream of the first wiper 20 in the conveying direction of the strip S. As shown in FIGS. 1 and 2, the non-woven wiper 26 may be disposed downstream of the rubber wiper 24 in the conveying direction of the strip S.

As shown in FIG. 7, the non-woven wiper 26 includes a core part 36 extending along the strip width direction of the strip S, and a non-woven fabric 34 attached around the core part 36 and disposed to be contactable with the rolled face (in FIG. 7, the rolled face Sa) of the strip S. As shown in FIG. 7, the non-woven wiper 26 may include a holding member 42 for holding the core part 36. In the exemplary embodiment shown in FIG. 7, the core part 36 is engaged with an engagement member 40 connected to the holding member 42 via a spring 46. Further, in the exemplary embodiment shown in FIG. 7, the pressing force (the force to press the core part 36 and the non-woven fabric 34 toward the strip S) by the pressing part acts on the core part 36 and the non-woven fabric 34 via the holding member 42 and the spring 46.

In the above-described embodiments, since the non-woven wiper 26 including the non-woven fabric 34 attached around the core part 36 is disposed downstream of the first wiper 20, the liquid that could not completely be removed from the rolled faces Sa, Sb of the strip S by the first wiper 20 can be removed by the non-woven wiper 26. Thus, the liquid can more reliably be removed from the rolled faces Sa, Sb of the strip S.

In some embodiments, a portion 38 (see FIG. 7), of the core part 36, adjacent to the non-woven fabric 34 in a strip thickness direction of the S strip may be formed from the graphite fiber reinforced resin composite material. The graphite fiber reinforced resin composite material may include the polyimide graphite fiber reinforced composite (PGFC).

According to the above-described embodiments, the portion 38, of the core part 36 to which the non-woven fabric 34 is attached, adjacent to the non-woven fabric 34 in the strip thickness direction of the strip S is formed from the graphite fiber reinforced resin composite material. Therefore, even if the non-woven fabric 34 is torn due to, for example, friction with the strip S and the core part 36 is exposed, the portion 38, of the core part 36, formed from the graphite fiber reinforced resin composite material contacts the strip S, hardly scratching the strip S. Therefore, even if the non-woven wiper 26 is used, it is possible to effectively suppress the scratch on the surface of the strip S.

A portion 44 (see FIG. 7), of the holding member 42 for holding the core part 36, including a face facing the strip S may be formed from the graphite fiber reinforced resin composite material. In this case, the strip S is hardly scratched even if the holding member 42 and the strip S contact each other, making it possible to effectively suppress the scratch on the surface of the strip S.

As shown in FIGS. 8 and 9, the second wiper 22 has the wiping member 12 which is contactable with the end face Se of the strip S in the strip width direction. The second wiper 22 has a flat plate part 50 extending along the strip thickness direction of the strip S, and the wiping member 12 of the second wiper 22 is supported by the flat plate part 50 via a spring 56 (first elastic member: see FIG. 8). The spring 56 corresponds to the pressing part, and a pressing force F3 (a force to press the wiping member 12 against the end face Se) from the pressing part (spring 56) is applied to the wiping member 12. In the case of a facility that processes only the strip S of approximately constant width, the flat plate part 50 may be fixed and immobile. However, since most facilities need to process the strips S of various widths, it is preferable to provide a conveying device (not shown) that allows for slide movement of the flat plate part 50 in the strip width direction of the strip S.

As shown in FIGS. 8 and 9, the second wiper 22 may include a clamping part 51 supported by the flat plate part 50 and configured to clamp the strip S from the strip thickness direction. The clamping part 51 shown in FIGS. 8 and 9 includes a pair of clamping members 52, 52 disposed on both sides of the strip S (the upper side and the lower side of the strip S) in the strip thickness direction. Between the pair of clamping members 52, 52, a spring 58 (second elastic member: see FIG. 9) is provided to apply, to the pair of clamping members 52, 52, a biasing force in a direction in which the pair of clamping members are separated from each other. Further, an actuator (not shown) is also provided to apply, to the pair of clamping members 52, 52, forces F4, F5 opposite in direction to the biasing force of the spring 58.

A portion 54, of the pair of clamping members 52, 52, facing the strip S may be formed from the graphite fiber reinforced resin composite material.

As described above, according to the configuration where the second wiper 22 is disposed which has the flat face 14 contactable with the end face Se of the strip S in the strip width direction, it is possible to effectively remove the liquid, such as the coolant, adhering to the end face Se of the strip S in the strip width direction. Further, since the wiping member 12 is formed from the graphite fiber reinforced resin composite material having the self-lubricating properties and the low coefficient of friction with metal material, the end face Se of the strip S is hardly scratched when the end face Se is wiped, and the replacement frequency of the wiping member 12 can be reduced.

Further, in the above-described embodiments, since the wiping member 12 is pressed toward the end face Se of the strip S by the spring 56 (first elastic member), even if the strip S moves in the strip width direction due to, for example, meandering of the strip S, the wiping member 12 follows the movement of the strip S, making it possible to maintain a state where the wiping member 12 is in contact with the end face Se of the strip S. Therefore, the liquid adhering to the end face Se of the strip S in the strip width direction can be removed more reliably.

Further, in the above-described embodiments, a posture of the wiping member 12 with respect to the strip S can be stabilized by clamping the strip from the strip thickness direction by the clamping part 51 supported by the flat plate part 50. Whereby, the state where the wiping member 12 is in contact with the end face Se of the strip S is maintained easily, the liquid adhering to the end face Se of the strip S in the strip width direction can be removed more reliably.

Further, in the above-described embodiments, the strip S can be clamped with the clamping part 51 from the strip thickness direction by operating the actuator to apply a force greater than the biasing force of the spring 58 (second elastic member) to the clamping members 52, 52. Furthermore, the clamping of the strip S with the clamping part 51 can be released by operating the actuator and making the force applied by the actuator to the clamping members 52, 52 smaller than the biasing force of the spring 58 (second elastic member).

In some embodiments, for example, as shown in FIGS. 1 and 2, the second wiper 22 is disposed downstream of the first wiper 20 in the conveying direction of the strip S. According to the above-described embodiments, since the second wiper 22 for

wiping the end face Se of the strip S in the strip width direction is disposed downstream of the first wiper 20 for wiping the rolled faces Sa, Sb of the strip S, the liquid, such as the coolant, laterally discharged from the rolled faces Sa, Sb of the strip S by the first wiper 20 and adhering to the end face Se of the strip S can effectively be removed by the second wiper 22. Hereinafter, the overview of the wiping apparatus and the rolling facility according

to some embodiments will be described.
(1) A wiping apparatus (10) according to at least one embodiment of the present invention is a wiping apparatus for removing a liquid from a surface of a strip (S) of metal being conveyed, including: a wiping member (12) having a flat face (14) disposed to be contactable with the surface of the strip. The wiping member is formed from a graphite fiber reinforced resin composite material.

In the above configuration (1), since the wiping member is formed from the graphite fiber reinforced resin composite material having self-lubricating properties and a low coefficient of friction with a metal material, heat or wear due to friction between the wiping member and the strip is hardly generated. Therefore, it is possible to reduce the replacement frequency of the wiping member, and since wear debris due to wear of the wiping member is hardly generated, it is possible to suppress the scratch on the surface of the strip due to the wear debris. Further, in the above configuration (1), since heat or wear due to friction between the wiping member and the strip is hardly generated, it is possible to bring the relatively wide flat face of the wiping member into contact with the surface of the strip. By thus bringing the relatively wide flat face of the wiping member into contact with the surface of the strip, a local force hardly acts on the contact portion of the wiping member and the surface of the strip in the state where the wiping member is pressed against the surface of the strip, and thus, unevenness is hardly formed on the surface of the wiping member. Therefore, it is possible to suppress partial contact between the surface of the wiping member and the strip, and it is possible to suppress the scratch on the surface of the strip due to the local surface pressure that may be generated by such partial contact. Therefore, according to the above configuration (1), the surface of the metal strip is hardly scratched when the surface of the strip is wiped, and the replacement frequency of the wiping member can be reduced.
(2) In some embodiments, in the above configuration (1), the wiping apparatus includes: a first wiper (20) including the wiping member having the flat face disposed to be contactable with a rolled face (Sa, Sb) of the strip.

In the above configuration (2), the wiping member forming the first wiper has the flat face disposed to be contactable with rolled face of the metal strip. Therefore, according to the above configuration (2), it is possible to obtain the wiping apparatus which hardly scratches the rolled face of the metal strip when the rolled face of the strip is wiped and can reduce the replacement frequency of the wiping member

In the present specification, of the surface of the strip, a face to be rolled by the mill roll or a face rolled by the mill roll (a face in contact with an outer circumferential surface of the mill roll) is referred to as the rolled face.
(3) In some embodiments, in the above configuration (2), the wiping member of the first wiper extends along a strip width direction of the strip.

According to the above configuration (3), since the wiping member of the first wiper extends along the strip width direction of the strip, the liquid on the rolled face of the strip conveyed along the longitudinal direction (conveying direction) of the strip can more effectively be removed by the first wiper.
(4) In some embodiments, in the above configuration (2) or (3), the wiping member of the first wiper extends in a direction oblique to a strip width direction of the strip.

In the above configuration (4), since the wiping member of the first wiper extends in the direction oblique to the strip width direction, the liquid removed from the surface of the strip by the wiping member and the foreign matter contained in the liquid are less likely to accumulate upstream of the wiping member and more likely to be discharged along the wiping member toward lateral to the strip. Therefore, according to the above configuration (4), it is possible to facilitate discharge of the foreign matter (a solid matter (such as metal powder etc. generated by wear of the mill roll or the strip, or wear debris etc. of the wiping member) mixed in the coolant) contained in the liquid, and it is possible to more effectively suppress the scratch on the surface of the strip due to the foreign matter.

As in the above configuration (4), by arranging the wiping member to be oblique to the strip width direction, the contact area between the wiping member and the strip is increased compared to a case where the wiping member is arranged so as to extend in the strip width direction. In this regard, as described in the above (1), since the wiping member is formed from the graphite fiber reinforced resin composite material (the material having the self-lubricating properties and the low coefficient of friction with the metal material), it is possible to effectively suppress the generation of heat or wear due to friction between the wiping member and the strip even if the contact area between the wiping member and the strip is increased. Thus, it is possible to achieve the above configuration (4).
(5) In some embodiments, in any of the above configurations (2) to (4), the wiping member has an upstream face (15) connected to the flat face at an upstream end of the flat face in a conveying direction of the strip, and an angle (θ) between the flat face and the upstream face is greater than 0 degrees and less than 90 degrees in a cross section orthogonal to a strip width direction of the strip.

According to the above configuration (5), the angle (hereinafter, the angle φ1) between the flat face and the upstream face of the wiping member is greater than 0 degrees and less than 90 degrees in the cross section orthogonal to the strip width direction. That is, an angle (hereinafter, the angle φ2) between the upstream face of the wiping member and a portion, of the rolled face of the strip, upstream of the wiping member is an obtuse angle in the above-described cross section. Therefore, compared to a case where the angle φ2 is not greater than 90 degrees, the liquid is easily discharged from a region between the upstream face of the wiping member and the rolled face of the strip. Therefore, it is possible to facilitate discharge of the foreign matter (a solid matter included in the coolant, such as metal powder generated by wear of the mill rolls or the strip or wear debris of the wiping member) contained in the liquid, and it is possible to more effectively suppress the scratch on the surface of the strip due to the foreign matter.
(6) In some embodiments, in any of the above configurations (2) to (5), the wiping apparatus includes: a rubber wiper (24) disposed downstream of the first wiper in a conveying direction of the strip and including a rubber member contactable with the rolled face of the strip.

According to the above configuration (6), since the rubber wiper including the rubber member contactable with the rolled face is disposed downstream of the first wiper, the liquid that could not completely be removed from the rolled face of the strip by the first wiper can be removed by the rubber wiper. Thus, the liquid can more reliably be removed from the rolled face of the strip.
(7) In some embodiments, in any of the above configurations (2) to (6), the wiping apparatus includes: a non-woven wiper (26) disposed downstream of the first wiper in a conveying direction of the strip. The non-woven wiper includes a core part (36) extending along a strip width direction of the strip, and a non-woven fabric (34) attached around the core part and disposed to be contactable with the rolled face of the strip.

According to the above configuration (7), since the non-woven wiper including the non-woven fabric attached around the core part is disposed downstream of the first wiper, the liquid that could not completely be removed from the rolled face of the strip by the first wiper can be removed by the non-woven wiper. Thus, the liquid can more reliably be removed from the rolled face of the strip.
(8) In some embodiments, in the above configuration (7), a portion (38), of the core part, adjacent to the non-woven fabric in a strip thickness direction of the strip is formed from the graphite fiber reinforced resin composite material.

According to the above configuration (8), the portion, of the core part to which the non-woven fabric is attached, adjacent to the non-woven fabric in the strip thickness direction of the strip is formed from the graphite fiber reinforced resin composite material. Therefore, even if the non-woven fabric is torn and the core part is exposed, the portion, of the core part, formed from the graphite fiber reinforced resin composite material contacts the strip, hardly scratching the strip. Therefore, even if the non-woven wiper is used, it is possible to effectively suppress the scratch on the surface of the strip.
(9) In some embodiments, in any of the above configurations (1) to (8), the wiping apparatus includes: a second wiper (22) including the wiping member having the flat face disposed to be contactable with an end face (Se) of the strip in a strip width direction.

In the above configuration (9), since the second wiper is disposed which has the flat face contactable with the end face of the strip in the strip width direction, it is possible to effectively remove the liquid adhering to the end face of the strip in the strip width direction.

Further, according to the above configuration (9), it is possible to obtain the wiping apparatus which hardly scratches the end face of the metal strip in the strip width direction when the end face is wiped and can reduce the replacement frequency of the wiping member.
(10) In some embodiments, in the above configuration (9), the wiping apparatus includes: a first wiper including the wiping member having the flat face facing a rolled face of the strip. The second wiper is disposed downstream of the first wiper in a conveying direction of the strip.

According to the above configuration (10), since the second wiper for wiping the end face of the strip in the strip width direction is disposed downstream of the first wiper for wiping the rolled face of the strip, the liquid laterally discharged from the rolled face of the strip by the first wiper and adhering to the end face of the strip can effectively be removed by the second wiper.
(11) In some embodiments, in any of the above configurations (1) to (10), the wiping apparatus includes: a pressing part configured to press the wiping member toward the surface of the strip.

According to the above configuration (11), since the wiping member is pressed toward the surface of the strip by the pressing part, the wiping member can reliably be brought into contact with the surface of the strip. Whereby, it is possible to effectively remove the liquid on the surface of the strip.
(12) In some embodiments, in any of the above configurations (1) to (11), the graphite fiber reinforced resin composite material includes a polyimide graphite fiber reinforced composite.

According to the above configuration (12), since the material including the polyimide graphite fiber reinforced composite is used as the graphite fiber reinforced resin composite material forming the wiping member, it is possible to effectively suppress heat or wear due to friction between the wiping member and the strip. Therefore, according to the above configuration (12), the surface of the metal strip is hardly scratched when the surface of the strip is wiped, and the replacement frequency of the wiping member can be reduced.
(13) A rolling facility (1) according to at least one embodiment of the present invention, includes: a mill roll (2) for rolling a strip (S) of metal; and the wiping apparatus (10) according to any one of the above (1) to (12), which is disposed downstream of the mill roll in a conveying direction of the strip.

In the above configuration (13), since the wiping member is formed from the graphite fiber reinforced resin composite material having self-lubricating properties and a low coefficient of friction with a metal material, heat or wear due to friction between the wiping member and the strip is hardly generated. Therefore, it is possible to reduce the replacement frequency of the wiping member, and since wear debris due to wear of the wiping member is hardly generated, it is possible to suppress the scratch on the surface of the strip due to the wear debris. Further, in the above configuration (13), since heat or wear due to friction between the wiping member and the strip is hardly generated, it is possible to bring the relatively wide flat face of the wiping member into contact with the surface of the strip. By thus bringing the relatively wide flat face of the wiping member into contact with the surface of the strip, a local force hardly acts on the contact portion of the wiping member and the surface of the strip in the state where the wiping member is pressed against the surface of the strip, and thus, unevenness is hardly formed on the surface of the wiping member. Therefore, it is possible to suppress partial contact between the surface of the wiping member and the strip, and it is possible to suppress the scratch on the surface of the strip due to the local surface pressure that may be generated by such partial contact. Therefore, according to the above configuration (13), the surface of the metal strip is hardly scratched when the surface of the strip is wiped, and the replacement frequency of the wiping member can be reduced.

Embodiments of the present invention were described in detail above, but the present invention is not limited thereto, and also includes an embodiment obtained by modifying the above-described embodiments and an embodiment obtained by combining these embodiments as appropriate.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, an expression of a shape such as a rectangular shape or a cylindrical shape shall not be construed as only the geometrically strict shape, but also includes a shape with unevenness or chamfered corners within the range in which the same effect can be achieved.

As used herein, the expressions “comprising”, “including” or “having” one constitutional element is not an exclusive expression that excludes the presence of other constitutional elements.

### REFERENCE SIGNS LIST

1 Rolling facility
2 Mill roll
4 Rolling mill
6 Guide roll
8 Winding device
10 Wiping apparatus
12 Wiping member
14 Flat face
15 Upstream face
20 First wiper
22 Second wiper
24 Rubber wiper
25 Rubber tube
26 Non-woven wiper
30 Holding member
32 Holding member
34 Non-woven fabric
36 Core part
38 Portion
40 Engagement member
42 Holding member
44 Portion
46 Spring
50 Flat plate part
51 Clamping part
52 Clamping member
54 Portion
56 Spring
58 Spring
100 Wiper
102 Corner
104 Region
S Strip
Sa Rolled face
Sb Rolled face
Se End face

1. A wiping apparatus for removing a liquid from a surface of a strip of metal being conveyed, comprising:
a wiping member having a flat face disposed to be contactable with the surface of the strip,
wherein the wiping member is formed from a graphite fiber reinforced resin composite material.

2. The wiping apparatus according to claim 1, comprising:
a first wiper including the wiping member having the flat face disposed to be contactable with a rolled face of the strip.

3. The wiping apparatus according to claim 2,
wherein the wiping member of the first wiper extends along a strip width direction of the strip.

4. The wiping apparatus according to claim 2,
wherein the wiping member of the first wiper extends in a direction oblique to a strip width direction of the strip.

5. The wiping apparatus according to claim 2,
wherein the wiping member has an upstream face connected to the flat face at an upstream end of the flat face in a conveying direction of the strip, and
wherein an angle between the flat face and the upstream face is greater than 0 degrees and less than 90 degrees in a cross section orthogonal to a strip width direction of the strip.

6. The wiping apparatus according to claim 2, comprising:
a rubber wiper disposed downstream of the first wiper in a conveying direction of the strip and including a rubber member contactable with the rolled face of the strip.

7. The wiping apparatus according to claim 2, comprising:
a non-woven wiper disposed downstream of the first wiper in a conveying direction of the strip,
wherein the non-woven wiper includes a core part extending along a strip width direction of the strip, and a non-woven fabric attached around the core part and disposed to be contactable with the rolled face of the strip.

8. The wiping apparatus according to claim 7,
wherein a portion, of the core part, adjacent to the non-woven fabric in a strip thickness direction of the strip is formed from the graphite fiber reinforced resin composite material.

9. The wiping apparatus according to claim 1, comprising:
a second wiper including the wiping member having the flat face disposed to be contactable with an end face of the strip in a strip width direction.

10. The wiping apparatus according to claim 9, comprising:
a first wiper including the wiping member having the flat face facing a rolled face of the strip,
wherein the second wiper is disposed downstream of the first wiper in a conveying direction of the strip.

11. The wiping apparatus according to claim 1, comprising:
a pressing part configured to press the wiping member toward the surface of the strip.

12. The wiping apparatus according to claim 1,
wherein the graphite fiber reinforced resin composite material includes a polyimide graphite fiber reinforced composite.

13. A rolling facility, comprising:
a mill roll for rolling a strip of metal; and
the wiping apparatus according to claim 1, which is disposed downstream of the mill roll in a conveying direction of the strip.
